(19) United States
(12) Patent Application Publication
(10) Pub. No.: US 2022/0173404 A1
(43) Pub. Date: Jun. 2, 2022

(54) ALL SOLID STATE BATTERY

(71) Applicant: TOYOTA JIDOSHA KABUSHIKI KAISHA, Toyota-shi (JP)

(72) Inventor: Takamasa OHTOMO, Miyoshi-shi (JP)

(73) Assignee: TOYOTA JIDOSHA KABUSHIKI KAISHA, Toyota-shi (JP)

(21) Appl. No.: 17/526,480

(22) Filed: Nov. 15, 2021

(30) Foreign Application Priority Data
Dec. 2, 2020 (JP) 2020-200375

(51) Int. Cl. H01M 4/66; H01M 4/13; H01M 10/0525; H01M 10/0585

(52) U.S. Cl. CPC H01M 4/662; H01M 4/663; H01M 4/667; H01M 2004/028; H01M 10/0525; H01M 10/0585; H01M 4/13

(57) ABSTRACT

A main object of the present disclosure is to provide an all solid state battery of which calorific value is little even when, for example, internal short circuit occurs. The present disclosure achieves the object by providing an all solid state battery comprising a cathode active material layer and a low meltability cathode current collector, wherein the low meltability cathode current collector contains a metal element, and a melting point of the low meltability cathode current collector is 170° C. or more and 420° C. or less.

### TECHNICAL FIELD

The present disclosure relates to an all solid state battery.

### BACKGROUND ART

An all solid state battery is a battery including a solid electrolyte layer between a cathode active material layer and an anode active material layer, and one of the advantages thereof is that the simplification of a safety device may be more easily achieved compared to a liquid-based battery including a liquid electrolyte containing a flammable organic solvent.

It has been known that a metal is used as a cathode current collector for collecting currents of the cathode active material layer and an anode current collector for collecting currents of the anode active material layer. For example, Patent Literature 1 discloses an electrode for all solid lithium battery provided with a metal layer, a conductive resin layer arranged on the metal layer, and an active material layer arranged on the conductive resin layer, and also discloses that an aluminum foil is used as a cathode metal layer and an aluminum foil or tin foil is used as an anode metal layer.

Also, Patent Literature 2 discloses an anode wherein at least a surface that contacts an anode mixture layer among surfaces of an anode current collecting layer comprises a material including an alloy of copper and a metal of which ionization tendency is higher than copper such as zinc, beryllium, and tin.

### CITATION LIST

### Patent Literatures

Patent Literature 1: Japanese Patent Application Laid-Open (JP-A) No. 2009-289534

Patent Literature 2: JP-A No. 2019-175838

### SUMMARY OF DISCLOSURE

### Technical Problem

For example, when internal short circuit occurs in an all solid state battery, current flows along with the internal short circuit to generate heat in the all solid state battery. The calorific value is preferably little. The present disclosure has been made in view of the above circumstances, and a main object of thereof is to provide an all solid state battery of which calorific value is little even when internal short circuit occurs.

### Solution to Problem

The present disclosure provides an all solid state battery comprising a cathode active material layer and a low meltability cathode current collector, wherein the low meltability cathode current collector contains a metal element, and a melting point of the low meltability cathode current collector is 170° C. or more and 420° C. or less.

According to the present disclosure, usage of the low meltability cathode current collector having the specified melting point allows an all solid state battery of which calorific value is little even when internal short circuit occurs.

In the disclosure, the low meltability cathode current collector may contain, as the metal element, a first metal element of which melting point in a simple substance of metal is 170° C. or more and 420° C. or less.

In the disclosure, the low meltability cathode current collector may contain at least one kind of Zn, Sn, Bi, Pb, Tl, Cd and Li as the first metal element.

In the disclosure, the low meltability cathode current collector may contain Zn as the first metal element.

In the disclosure, the low meltability cathode current collector may contain Sn as the first metal element.

In the disclosure, the low meltability cathode current collector may be a simple substance of metal containing the metal element.

In the disclosure, the low meltability cathode current collector may be an alloy containing the metal element.

In the disclosure, the alloy may contain a first metal element of which melting point in a simple substance of metal is 170° C. or more and 420° C. or less, and a second metal element of which melting point in a simple substance of metal is more than 420° C.

In the disclosure, the low meltability cathode current collector may include a coating layer containing a carbon material on a surface of the cathode active material layer side.

In the disclosure, the coating layer may contain an inorganic filler.

In the disclosure, the all solid state battery comprises a unit cell; and the unit cell includes: an anode current collector, a first structure body arranged on one surface of the anode current collector, and a second structure body arranged on the other surface of the anode current collector; the first structure body includes a first anode active material layer, a first solid electrolyte layer, a first cathode active material layer and a first cathode current collector in an order along with a thickness direction from the anode current collector side; the second structure body includes a second anode active material layer, a second solid electrolyte layer, a second cathode active material layer and a second cathode current collector in an order along with a thickness direction from the anode current collector side; and at least one of the first cathode current collector and the second cathode current collector may be the low meltability cathode current collector.

In the disclosure, the all solid state battery comprises a plurality of unit cells; the plurality of unit cells are layered along with a thickness direction; and in the layered plurality of unit cells, when a cathode current collector positioned in the outermost side is regarded as an outermost cathode current collector, only the outermost cathode current collector may be the low meltability cathode current collector.

### Advantageous Effects of Disclosure

The all solid state battery in the present disclosure exhibits an effect such that the calorific value is little even when internal short circuit occurs.

### BRIEF DESCRIPTION OF DRAWINGS

FIG. 1 is a schematic cross-sectional view exemplifying the all solid state battery in the present disclosure.

FIG. 2 is a schematic cross-sectional view exemplifying the cathode in the present disclosure.

FIG. 3 is a schematic cross-sectional view exemplifying the all solid state battery in the present disclosure.

FIG. 4 is a schematic cross-sectional view exemplifying the unit cell in the present disclosure.

FIG. 5 is a schematic cross-sectional view exemplifying the all solid state battery in the present disclosure.

FIG. 6 is a schematic cross-sectional view exemplifying the all solid state battery in the present disclosure.

### DESCRIPTION OF EMBODIMENTS

The all solid state battery in the present disclosure is hereinafter explained in details with reference to drawings. Each drawing described as below is a schematic view, and the size and the shape of each portion are appropriately exaggerated in order to be understood easily. Further, in each drawing, hatchings or reference signs are appropriately omitted. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

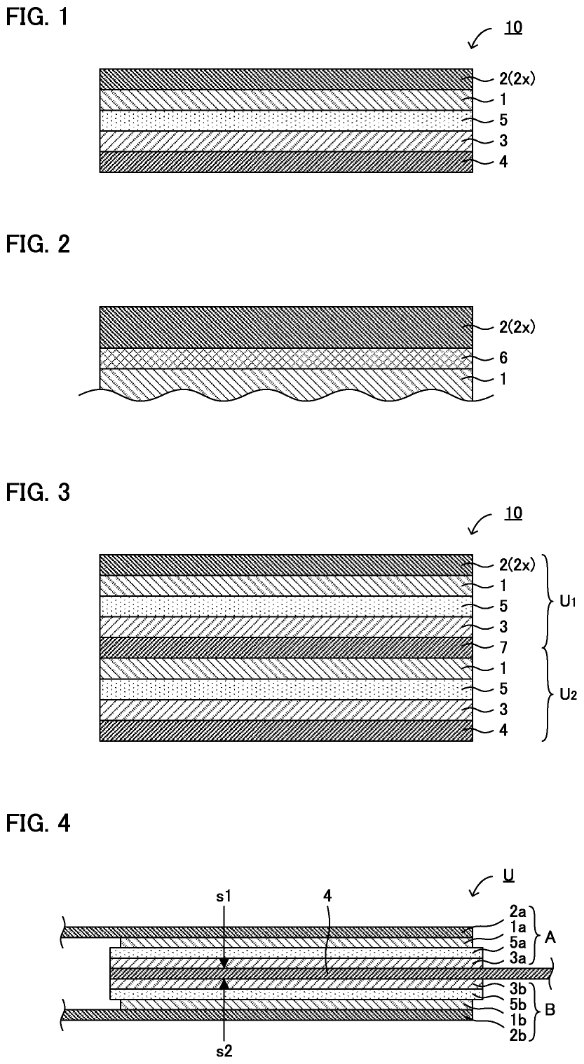

FIG. 1 is a schematic cross-sectional view exemplifying the all solid state battery in the present disclosure. All solid state battery 10 illustrated in FIG. 1 includes cathode active material layer 1, cathode current collector 2 for collecting currents of the cathode active material layer 1, anode active material layer 3, anode current collector 4 for collecting currents of the anode active material layer 3, and solid electrolyte layer 5 arranged between the cathode active material layer 1 and the anode active material layer 3. The cathode current collector 2 is a low meltability cathode current collector 2x with a specified melting point.

According to the present disclosure, usage of the low meltability cathode current collector having the specified melting point allows an all solid state battery of which calorific value is little even when internal short circuit occurs. As described above, when internal short circuit occurs in an all solid state battery, current flows along with the internal short circuit to generate heat. Examples of the reasons for the occurrence of internal short circuit may include contamination of a conductive foreign substance (such as a metal piece) during production of a battery, and pricking of an all solid state battery by a conductive member (such as a metal member).

The inventor of the present disclosure focuses on the melting point of the cathode current collector to achieve reduction of the calorific value. In particular, his idea is to use a cathode current collector of which melting point is low (low meltability cathode current collector), and to positively fuse the cathode current collector when heat is generated in the all solid state battery. In reality, it has been confirmed that the reduction of the calorific value was achieved when the low meltability cathode current collector was used since electron conducting path was shut off (shut-down function was expressed). Conventionally, Al foil has been widely known as a cathode current collector, but since the melting point of the Al foil is 660° C. and high, its fusion does not usually occur even when current flows along with internal short circuit to generate heat. In contrast, in the present disclosure, the low meltability cathode current collector is used so as to generate its fusion positively, and thus the reduction of calorific value may be achieved.

There are no particular limitations on a part where the fusion of the low meltability cathode current collector occurs, but for example, when a conductive member is pricked as in the later described needle pricking test, the fusion occurs first in a region where the conductive member contacts with the low meltability cathode current collector. Also, when a conductive foreign substance is present inside the battery and the substance is in contact with the low meltability cathode current collector, the fusion occurs first in that contact part. Also, the shut-down function may be expressed when the low meltability cathode current collector overall fuses or when the tab part of the low meltability cathode current collector fuses due to generated heat.

Also, for example, the voltage of a lithium ion battery increases to about 3.0 to 4.2 V (vs Li/Lil during charge, and thus there is a possibility that corrosion may occur in a metal that is ionized at lower potential than the standard electrode potential −0.045 to 1.155 V (vs SHE) (Li:−3.045 V vs SHE). For example, the standard electrode potential of Zn and Sn are as below.

Zn²⁺+2e⁻=Zn (−0.7626 V)

Sn²⁺+2e⁻=Sn (−0.1375 V)

In particular, in the case of a lithium ion battery using liquid electrolyte, elution of metal is remarkable, and thus corrosion occurs when Zn or Sn is used as the cathode current collector. On the other hand, in the case of an all solid lithium ion battery, a solid electrolyte without flowability is used and thus, elution of metal does not easily occur and Zn or Sn can be used as the cathode current collector. Incidentally, in a lithium ion battery using liquid electrolyte, when Al (−1.7 V) is used as the cathode current collector, it can be used as the cathode current collector since an AlF₃ coating film is formed by a fluorine-containing compound (such as LiPF₆) included in the liquid electrolyte.

Also, in particular, it has been general to use Al foil as the cathode current collector in an all solid state battery using a sulfide solid electrolyte. The reason therefor is because sulfurization of Al foil does not easily occurs and there has been no big problem on the usage. In the present disclosure, it is not until focusing on positively fusing the cathode current collector that the low meltability cathode current collector of which melting point is lower than that of Al foil (660° C.) is adopted. Also, there is a possibility that the deterioration of an anode current collector may proceed due to volume change caused by Li alloying during charge and discharge; however, the deterioration of the cathode current collector due to volume change caused by Li alloying does not occur even when the low meltability cathode current collector is used because the Li alloying of the cathode current collector does not usually occur during charge.

1. Cathode The cathode in the present disclosure includes a cathode active material layer containing a cathode active material, and a cathode current collector for collecting currents of the cathode active material layer.

(1) Cathode Current Collector

The all solid state battery in the present disclosure comprises, as a cathode current collector, a low meltability cathode current collector, wherein the low meltability cathode current collector contains a metal element, and the melting point of the low meltability cathode current collector is 170° C. or more and 420° C. or less.

There are no particular limitations on the metal element included in the low meltability cathode current collector. The low meltability cathode current collector may contain just one kind of the metal element, and may contain two kinds or more thereof. It is preferable that the low meltability cathode current collector contains, as the metal element, a first metal element of which melting point in a simple substance of metal is 170° C. or more and 420° C. or less. The low meltability cathode current collector may contain just one kind of the first metal element, and may contain two kinds or more thereof. Examples of the first metal element may include Zn, Sn, Bi, Pb, Tl, Cd, and Li.

The low meltability cathode current collector may or may not contain, as the metal element, a second metal element of which melting point in a simple substance of metal is more than 420° C. Examples of the second metal element may include Sb, Cu, Ag, Ni and Ge. Also, the low meltability cathode current collector may or may not contain, as the metal element, a third metal element of which melting point in a simple substance of metal is less than 170° C. Examples of the third metal element may include Cs, In and Ga.

The low meltability cathode current collector may be a simple substance of metal, and may be an alloy. In the latter case, the low meltability cathode current collector preferably contains at least the first metal element, and preferably contains the first metal element as a main component. “As a main component” means that the weight proportion of the metal element is the most among all the metal elements included in the alloy. Also, the low meltability cathode current collector preferably contains Zn as the metal element, and preferably contains Zn as a main component. Also, the low meltability cathode current collector preferably contains Sn as the metal element, and preferably contains Sn a main component.

The melting point of the low meltability cathode current collector is usually 170° C. or more, may be 180° C. or more, and may be 200° C. or more. If the melting point of the low meltability cathode current collector is too low, there is a possibility that the low meltability cathode current collector may be fused during the production of an all solid state battery. Meanwhile, the melting point of the low meltability cathode current collector is usually 420° C. or less and may be 350° C. or less. If the melting point of the low meltability cathode current collector is too high, there is a possibility that the shut-down effect of electron conducting path by the fusion of the low meltability cathode current collector may not be sufficiently obtained.

Here, the melting point of simple substance of Zn is 420° C., the melting point of simple substance of Sn is 232° C., the melting point of simple substance of Bi is 271° C., the melting point of simple substance of Pb is 328° C., the melting point of simple substance of Tl is 304° C., the melting point of simple substance of Cd is 321° C., and the melting point of simple substance of Li is 180° C. Also, the melting point of a Sn-Sb alloy depends on its composition, but it is about 240° C., for example.

Examples of the shape of the low meltability cathode current collector may include a foil shape and a mesh shape. The thickness of the low meltability cathode current collector is, for example, 0.1 μm or more and may be 1 μm or more. If the low meltability cathode current collector is too thin, there is a possibility that the current collecting properties are degraded. Meanwhile, the thickness of the low meltability cathode current collector is, for example, 1 mm or less and may be 100 μm or less. If the low meltability cathode current collector is too thick, there is a possibility that the volume energy density of the all solid state battery may be decreased.

Also, as shown in FIG. 2, the low meltability cathode current collector 2x may include coating layer 6 containing a carbon material on a surface of the cathode active material layer 1 side. When the coating layer 6 is arranged between the low meltability cathode current collector 2x and the cathode active material layer 1, the contact resistance of the both may be reduced.

The coating layer is a layer containing at least a carbon material. Examples of the carbon material may include carbon black such as furnace black, acetylene black, Ketjen black, and thermal black; carbon fiber such as carbon nanotube and carbon nanofiber; activated carbon, carbon, graphite, graphene, and fullerene. Examples of the shape of the carbon material may include a granular shape. The proportion of the carbon material included in the coating layer is, for example, 5 volume % or more and 95 volume % or less.

The coating layer may further contain a resin. For example, by adding a lot of resin, a coating layer with flexibility may be obtained. With high flexibility, contact area of the coating layer and the cathode active material layer on the cathode current collector is enlarged by a restraining pressure applied to the battery, and the contact resistance may be reduced. Also, when a resin is added a lot, a coating layer having PTC properties may be obtained. Here, PTC refers to Positive Temperature Coefficient, and the PTC properties mean properties where resistance changes with a positive coefficient along with temperature rise. In other words, the volume of the resin included in the coating layer expands along with temperature rise, and the resistance of the coating layer increases. As a result, the calorific value can be reduced even when internal short circuit occurs.

Examples of the resin may include a thermoplastic resin. Examples of the thermoplastic resin may include polyvinylidene fluoride (PVDF), polypropylene, polyethylene, polyvinyl chloride, polystyrene, an acrylonitrile butadiene styrene (ABS) resin, a methacrylic resin, polyamide, polyester, polycarbonate, and polyacetal. The melting point of the resin is, for example, 80° C. or more and 300° C. or less. The proportion of the resin included in the coating layer is, for example, 5 volume % or more, and may be 50 volume % or more. Meanwhile, the proportion of the resin included in the coating layer is, for example, 95 volume % or less.

The coating layer may or may not contain an inorganic filler. A coating layer with high PTC properties may be obtained in the former case, and a coating layer with high electron conductivity may be obtained in the latter case. In an all solid state battery, usually, restraining pressure is applied along with a thickness direction, and thus the resin included in the coating layer may be deformed or may flow due to the restraining pressure, and there is a possibility that the PTC properties may not be sufficiently exhibited. In contrast, when a hard inorganic filler is added to the coating layer, the PTC properties can be sufficiently exhibited even when affected by the restraining pressure.

Examples of the inorganic filler may include a metal oxide and a metal nitride. Examples of the metal oxide may include alumina, zirconia and silica, and examples of the metal nitride may include silicon nitride. The average particle size (D₅₀) of the inorganic filler is, for example, 50 nm or more and 5 μm or less, and may be 100 nm or more and 2 μm or less. Also, the content of the inorganic filler in the coating layer is, for example, 5 volume % or more and 90 volume % or less.

The thickness of the coating layer is, for example, 1 μm or more and 20 μm or less, may be 1 μm or more and 10 μm or less.

(2) Cathode Active Material Layer

The cathode active material layer contains at least a cathode active material, and may contain at least one of a solid electrolyte, a conductive material and a binder, as required.

Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O2; a spinel type active material such as LiMn₂O₄, Li(Ni_{0.5}Mn_{1.5})O₄ and Li₄Ti₅O₁₂; and an olivine type active material such as LiFePO₄, LiMnPO₄, LiNiPO₄, and LiCoPO₄. Also, as the cathode active material, sulfur (S) or lithium sulfide (Li₂S) may be used.

Also, a protective layer containing Li-ion conductive oxide may be formed on the surface of the cathode active material. The reason therefor is to inhibit the reaction of the cathode active material and the solid electrolyte. Examples of the Li-ion conductive oxide may include LiNbO₃. The thickness of the protective layer is, for example, 0.1 nm or more and 100 nm or less, and may be 1 nm or more and 20 nm or less.

Examples of the shape of the cathode active material may include a granular shape. The average particle size (D₅₀) of the cathode active material is, for example, 10 nm or more and 50 μm or less, and may be 100 nm or more and 20 μm or less. The proportion of the cathode active material in the cathode active material layer is, for example, 50 weight % or more, and may be 60 weight % or more and 99 weight % or less.

Examples of the solid electrolyte may include an inorganic solid electrolyte such as a sulfide solid electrolyte and an oxide solid electrolyte. It is preferable that the sulfide solid electrolyte contains Li, A (A is at least one kind of P, Si, Ge, Al and B), and S. Also, the sulfide solid electrolyte preferably includes an anion structure of an ortho composition (PS₄³⁻ structure, SiS₄⁴⁻ structure, GeS₄⁴⁻ structure, AlS₃³⁻ structure, and BS₃³⁻ structure) as the main component of an anion. The proportion of the anion structure of the ortho composition with respect to all the anion structures in the sulfide solid electrolyte is, for example, 50 mol % or more and may be 70 mol % or more. Also, the sulfide solid electrolyte may contain a lithium halide. Examples of the lithium halide may include LiCl, LiBr, and LiI.

Also, the solid electrolyte may be glass, may be crystallized glass (glass ceramic), and may be a crystal material. Examples of the shape of the solid electrolyte may include a granular shape.

Examples of the conductive material may include a carbon material such as acetylene black (AB), Ketjen black (KB), carbon fiber, carbon nanotube (CNT), and carbon nanofiber (CNF). Further, examples of the binder may include a rubber-based binder such as butylene rubber (BR) and styrene butadiene rubber (SBR), and a fluoride-based binder such as polyvinylidene fluoride (PVDF). Also, the thickness of the cathode active material layer is, for example, 0.1 μm or more and 300 μm or less, and may be 0.1 μm or more and 100 μm or less.

2. Anode

The anode in the present disclosure includes an anode active material layer containing an anode active material, and an anode current collector for collecting currents of the anode active material layer. The anode active material layer contains at least an anode active material, and may contain at least one of a solid electrolyte, a conductive material and a binder, as required.

Examples of the anode active material may include a metal active material, a carbon active material, and an oxide active material. Examples of the metal active material may include a simple substance of metal and a metal alloy. Examples of the metal element included in the metal active material may include Si, Sn, Li, In and Al. The metal alloy is preferably an alloy containing the aforementioned metal element as a main component. The metal alloy may be a two-component alloy, and may be a multi component alloy of three components or more. Examples of the carbon active material may include methocarbon microbeads (MCMB), highly oriented pyrolytic graphite (HOPG), hard carbon, and soft carbon. Also, examples of the oxide active material may include a lithium titanate such as Li₄Ti₅O₁₂.

The solid electrolyte, the conductive material and the binder to be used in the anode active material layer are in the same contents as those described in “1. Cathode” above; thus, the descriptions herein are omitted. Also, the thickness of the anode active material layer is, for example, 0.1 μm or more and 300 μm or less, and may be 0.1 μm or more and 100 μm or less.

Examples of the metal element included in the anode current collector may include Cu, Fe, Ti, Ni, Zn and Co. The anode current collector may be a simple substance of the aforementioned metal element, and may be an alloy containing the aforementioned metal element as a main component. Examples of the shape of the anode current collector may include a foil shape and a mesh shape. The thickness of the anode current collector is, for example, 0.1 μm or more and 1 mm or less, and may be 1 μm or more and 100 μm or less.

3. Solid Electrolyte Layer

The solid electrolyte layer is a layer arranged between the cathode active material layer and the anode active material layer. Also, the solid electrolyte layer contains at least a solid electrolyte, and may further contain a binder as required. The solid electrolyte and the binder to be used in the solid electrolyte layer are in the same contents as those described in “1. Cathode” above; thus, the descriptions herein are omitted.

The content of the solid electrolyte in the solid electrolyte layer is, for example, 10 weight % or more and 100 weigh t% or less, and may be 50 weight % or more and 100 weight % or less. Also, the thickness of the solid electrolyte layer is, for example, 0.1 μm or more and 300 μm or less, and may be 0.1 μm or more and 100 μm or less.

4. All Solid State Battery

The all solid state battery in the present disclosure comprises a unit cell. The “unit cell” refers to a unit configuring the battery element in the all solid state battery, which includes a cathode current collector, a cathode active material layer, a solid electrolyte layer, an anode active material layer, and an anode current collector. Incidentally, the cathode current collector in one unit cell may be used in common as the cathode current collector or the anode current collector in the other unit cell. Similarly, the anode current collector in one unit cell may be used in common as the anode current collector or the cathode current collector in the other unit cell.

The all solid state battery in the present disclosure may include just one of the unit cell, and may include two or more thereof. In the latter case, a plurality of the unit cells are usually layered along with the thickness direction. Also, the plurality of the unit cells may be connected in series and may be connected in parallel. For example, all solid state battery 10 shown in FIG. 1 includes just one of the unit cell including cathode current collector 2, cathode active material layer 1, solid electrolyte layer 5, anode active material layer 3 and anode current collector 4. On the other hand, all solid state battery 10 shown in FIG. 3 includes unit cells U₁ and U₂ and these are connected in series. Incidentally, intermediate current collector 7 shown in FIG. 3 works both as the anode current collector in the unit cell U₁ and as the cathode current collector in the unit cell U₂. The intermediate current collector 7 may be the above described low meltability cathode current collector (low meltability current collector).

FIG. 4 is a schematic cross-sectional view exemplifying the unit cell in the present disclosure. Unit cell U shown in FIG. 4 includes anode current collector 4, first structure body A arranged on one surface s1 of the anode current collector 4, and second structure body B arranged on the other surface s2 of the anode current collector 4. Also, the first structure body A includes, in the order along with the thickness direction from the anode current collector 4 side, first anode active material layer 3a, first solid electrolyte layer 5a, first cathode active material layer la, and first cathode current collector 2a. Meanwhile, the second structure body B includes, in the order along with the thickness direction from the anode current collector 4 side, second anode active material layer 3b, second solid electrolyte layer 5b, second cathode active material layer 1b, and second cathode current collector 2b. At least one of the first cathode current collector 2a and the second cathode current collector 2b is preferably the above described low meltability cathode current collector.

In unit cell U shown in FIG. 4, constitutions of the layers other than anode current collector 4 are symmetry on the basis of the anode current collector 4, and thus stress due to difference in stretchability between the cathode active material layer and the anode active material layer is not easily generated. As a result, occurrence of breakage of the anode current collector can be suppressed.

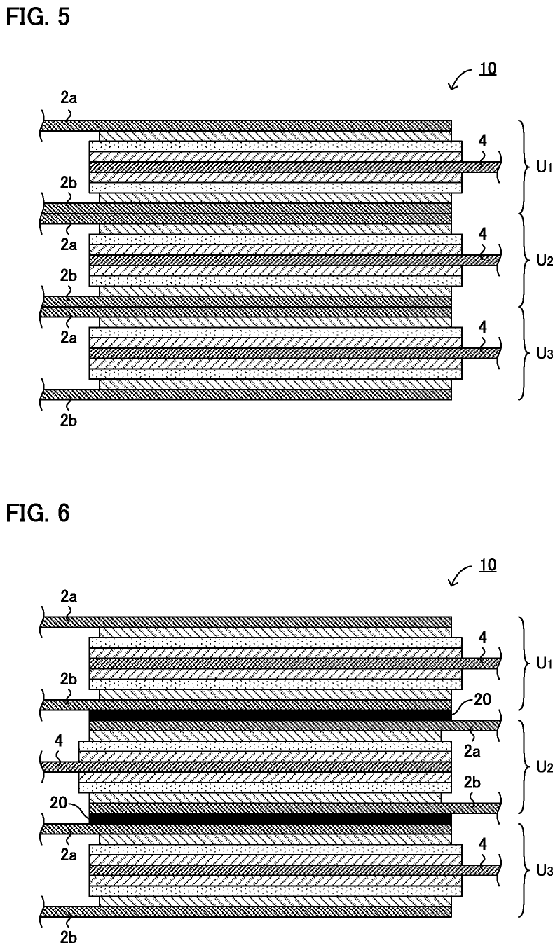

Also, the all solid state battery in the present disclosure may include a plurality of the unit cell U shown in FIG. 4. All solid state battery 10 shown in FIG. 5 includes a plurality of the unit cell U shown in FIG. 4 (unit cells U₁ to U₃), and the plurality of the unit cell U are connected in parallel. In specific, all the cathode current collector 2a and the cathode current collector 2b in the unit cells U₁ to U₃ are electronically connected, and all the anode current collector 4 in the unit cells U₁ to U₃ are electronically connected, and thus the unit cells U₁ to U₃ are connected in parallel. It is preferable that at least one of the cathode current collector 2a and the cathode current collector 2b in the unit cells U₁ to U₃ is the above described low meltability cathode current collector. Incidentally, in FIG. 5, the cathode current collector 2a and the cathode current collector 2b facing to each other (such as the cathode current collector 2b in the unit cell U₁ and the cathode current collector 2a in the unit cell U₂) are different members, but they may be the same member (one cathode current collector).

On the other hand, all solid state battery 10 shown in FIG. 6 includes a plurality of the unit cell U shown in FIG. 4 (unit cells U₁ to U₃), insulating member 20 is arranged in between each unit cell U, and the plurality of the unit cell U are connected in series. In specific, in unit cells U₁ to U₃, each of the cathode current collector 2a and the cathode current collector 2b are electronically connected, the anode current collector 4 in the unit cell U₁ is electronically connected with the cathode current collector 2a and the cathode current collector 2b in the unit cell U₂, and the anode current collector 4 in the unit cell U₂ is electronically connected with the cathode current collector 2a and the cathode current collector 2b in the unit cell U₃. It is preferable that at least one of the cathode current collector 2a and the cathode current collector 2b in the unit cells U₁ to U₃ is the above described low meltability cathode current collector.

Also, in the layered plurality of unit cells, the cathode current collector positioned in the outermost side is regarded as an outermost cathode current collector. For example, in FIG. 5 and FIG. 6, the cathode current collector 2a in the unit cell U₁ and the cathode current collector 2b in the unit cell U₃ respectively correspond to the outermost cathode current collector. In the present disclosure, the outermost cathode current collector is preferably the low meltability cathode current collector. For example, when the conductive member pricks the all solid state battery to cause short circuit, the contact area of the conductive member and the outermost cathode current collector increases. Electron conducting path in that contact part is shut off by the fusion of the outermost cathode current collector, and thus the calorific value may be further reduced. Also, as shown in FIG. 5 and FIG. 6, when the outermost cathode current collectors are present in the both ends, at least one of those outermost cathode current collectors is preferably the low meltability cathode current collector, and the both may be the low meltability cathode current collector. Also, in the present disclosure, only the outermost cathode current collector may be the low meltability cathode current collector. In this case, all the cathode current collectors other than the outermost cathode current collector may be high meltability cathode current collectors, of which melting point is more than 420° C.

The all solid state battery in the present disclosure may include an outer package for storing the cathode, the solid electrolyte layer, and the anode. The outer package may or may not be flexible. As an example of the former case, an aluminum laminate film can be exemplified, and as an example of the latter case, a case made of SUS can be exemplified.

Also, to the all solid state battery in the present disclosure, restraining pressure may be applied by a restraining jig. The restraining pressure is, for example, 0.1 MPa or more, may be 1 MPa or more, and may be 5 MPa or more. Meanwhile, the restraining pressure is, for example, 100 MPa or less, may be 50 MPa or less, and may be 20 MPa or less.

Also, the kind of the all solid state battery in the present disclosure is not particularly limited, but is typically an all solid lithium ion secondary battery. Further, examples of the application of the all solid state battery in the present disclosure may include a power source for vehicles such as hybrid electric vehicles, battery electric vehicles, fuel cell electric vehicles and diesel powered automobiles. In particular, it is preferably used as a power source for driving hybrid electric vehicles or battery electric vehicles. Also, the all solid state battery in the present disclosure may be used as a power source for moving bodies other than vehicles (such as rail road transportation, vessel and airplane), and may be used as a power source for electronic products such as information processing equipment.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

<Production of Anode>

An anode active material (Si particles, average particle size 2.5 μm), a sulfide solid electrolyte (10LiI·15LiBr·75(0.75Li₂S·0.25P₂S₅), average particle size 0.5 μm), a conductive material (VGCF-H), and a binder (SBR) were weighed so as to be the anode active material:the sulfide solid electrolyte:the conductive material:the binder=62.1:31.7:5.0:1.2 in the weight ratio, and mixed together with a dispersion medium (diisobutyl keton). The obtained mixture was dispersed by an ultrasonic homogenizer (UH-50 from SMT Corporation) to obtain slurry. The obtained slurry was pasted on an anode current collector (Ni foil, 22 pm thick) by a blade coating method using an applicator, and dried at 100° C. for 30 minutes. After that, the product was punched out into a size of 1 cm2 to obtain an anode including the anode active material layer and the anode current collector. The thickness of the anode active material layer was 50 μm.

<Production of Cathode>

A cathode active material coated with LiNbO₃ using a granulating-coating machine (LiNi_{1/3}Co_{1/3}Mn_{1/3}O₂, average particle size 10 μm), a sulfide solid electrolyte (10LiI·15LiBr·75(0.75Li₂S·0.25P₂S₅), average particle size 0.5 μm), a conductive material (VGCF-H), and a binder (SBR) were weighed so as to be the cathode active material:the sulfide solid electrolyte:the conductive material:the binder=87.6:10.4:1.3:0.7 in the weight ratio, and mixed together with a dispersion medium (diisobutyl keton). The obtained mixture was dispersed by an ultrasonic homogenizer (UH-50 from SMT Corporation) to obtain slurry. The obtained slurry was pasted on a cathode current collector (Zn foil, 50 μm thick) by a blade coating method using an applicator, and dried at 100° C. for 30 minutes. After that, the product was punched out into a size of 1 cm² to obtain a cathode including the cathode active material layer and the cathode current collector. The thickness of the cathode active material layer was 80 μm.

<Production of Solid Electrolyte Layer>

A sulfide solid electrolyte (10LiI·15LiBr·75(0.75Li₂S·0.25P₂S₅), average particle size 2.0 μm) and a binder (SBR) were weighed so as to be the sulfide solid electrolyte:binder=99.6:0.4 in the weight ratio, and mixed together with a dispersion medium (diisobutyl keton). The obtained mixture was dispersed by an ultrasonic homogenizer (UH-50 from SMT Corporation) to obtain slurry. The obtained slurry was pasted on Al foil (15 μm thick) by a blade coating method using an applicator, and dried at 100° C. for 30 minutes. After that, the product was punched out into a size of 1 cm² to obtain a solid electrolyte layer formed on the Al foil. The thickness of the solid electrolyte layer was 20 μm.

### <Production of All Solid State Batter>

The obtained solid electrolyte layer and the obtained cathode active material layer were faced to each other, pressed at the linear pressure of 1.6 t/cm by a roll-pressing method, and then the Al foil was peeled off from the solid electrolyte layer. Thereby, the solid electrolyte layer was transferred onto the cathode active material layer. The solid electrolyte layer transferred onto the cathode active material layer, and the anode active material layer were faced to each other, and pressed at the linear pressure of 5.0 t/cm by a roll-pressing method. After that, a tab for collecting currents was respectively arranged on the cathode current collector and the anode current collector and sealed by laminate to obtain an all solid state battery.

### Example 2

An all solid state battery was obtained in the same manner as in Example 1, except that Sn foil (50 μm thick) was used as the cathode current collector.

### Comparative Example 1

An all solid state battery was obtained in the same manner as in Example 1, except that Al foil (50 μm thick) was used as the cathode current collector.

### Evaluation

Needle pricking tests were conducted to the all solid state batteries obtained in Examples 1 and 2 and Comparative Example 1. In specific, the all solid state battery was restrained at 5 MPa using a restraining plate including a hole for needle pricking. After that, the battery was pricked by a needle having φ 1 mm at the point angle 20° in the condition of 0.1 mm/s speed and 0.4 mm depth, while being CC-CV charged (maximum current value 20 A) at 4.35 V. Calorific value (W) was calculated by the product of the voltage (V) and the inflow current (A). The results are shown in Table 1.

TABLE 1

| | Cathode current collector | | |
|---|---|---|---|
| | Metal | Melting point (° C.) | Calorific value (W) |
| Example 1 | Zn | 420 | 152 |
| Example 2 | Sn | 232 | 144 |
| Comparative | Al | 660 | 218 |
| Example 1 | | | |

As shown in Table 1, it was confirmed that the calorific values of Examples 1 and 2 were less than that of Comparative Example 1. This is presumably because the melting point of the cathode current collector used in Examples 1 and 2 was respectively lower than the melting point of the cathode current collector used in Comparative Example 1, and during internal short circuit, the electron conduction path in the contact part of the cathode current collector and the needle was shut off by the fusion of the cathode current collector.

### Reference Example

Effects on elution of the cathode current collector in the all solid state batteries obtained in Examples 1 and 2, and Comparative Example 1 were examined. In specific, trickle charge was conducted to the all solid state batteries in the conditions of 60° C., 2 weeks, and 4.35 V. Before and after the trickle charge, the battery was discharged for 10 seconds at the currency 5.2 mA/cm² (equivalent to 2C), and its resistance was calculated. The resistance increase rate was 106% in Comparative Example 1 (Al), 108% in Example 1 (Zn), and 107% in Example 2 (Sn) respectively. It was suggested that the effect of corrosion in the all solid state battery was limited since the resistance increase rates of Examples 1, 2, and Comparative Example 1 were equivalent.

### REFERENCE SIGNS LIST

1 cathode active material layer

2 cathode current collector

3 anode active material layer

4 anode current collector

5 solid electrolyte layer

6 coating layer

19 all solid state battery

What is claimed is:

1. An all solid state battery comprising a cathode active material layer and a low meltability cathode current collector, wherein
the low meltability cathode current collector contains a metal element, and a melting point of the low meltability cathode current collector is 170° C. or more and 420° C. or less.

2. The all solid state battery according to claim 1, wherein the low meltability cathode current collector contains, as the metal element, a first metal element of which melting point in a simple substance of metal is 170° C. or more and 420° C. or less.

3. The all solid state battery according to claim 2, wherein the low meltability cathode current collector contains at least one kind of Zn, Sn, Bi, Pb, Tl, Cd and Li as the first metal element.

4. The all solid state battery according to claim 2, wherein the low meltability cathode current collector contains Zn as the first metal element.

5. The all solid state battery according to claim 2, wherein the low meltability cathode current collector contains Sn as the first metal element.

6. The all solid state battery according to claim 1, wherein the low meltability cathode current collector is a simple substance of metal containing the metal element.

7. The all solid state battery according to claim 1, wherein the low meltability cathode current collector is an alloy containing the metal element.

8. The all solid state battery according to claim 7, wherein the alloy contains a first metal element of which melting point in a simple substance of metal is 170° C. or more and 420° C. or less, and a second metal element of which melting point in a simple substance of metal is more than 420° C.

9. The all solid state battery according to claim 1, wherein the low meltability cathode current collector includes a coating layer containing a carbon material on a surface of the cathode active material layer side.

10. The all solid state battery according to claim 9, wherein the coating layer contains an inorganic filler.

11. The all solid state battery according to claim 1, wherein the all solid state battery comprises a unit cell; and
the unit cell includes:
an anode current collector,
a first structure body arranged on one surface of the anode current collector, and
a second structure body arranged on the other surface of the anode current collector;
the first structure body includes a first anode active material layer, a first solid electrolyte layer, a first cathode active material layer and a first cathode current collector in an order along with a thickness direction from the anode current collector side;
the second structure body includes a second anode active material layer, a second solid electrolyte layer, a second cathode active material layer and a second cathode current collector in an order along with a thickness direction from the anode current collector side; and
at least one of the first cathode current collector and the second cathode current collector is the low meltability cathode current collector.

12. The all solid state battery according to claim 1, wherein the all solid state battery comprises a plurality of unit cells;
the plurality of unit cells are layered along with a thickness direction; and
in the layered plurality of unit cells, when a cathode current collector positioned in the outermost side is regarded as an outermost cathode current collector, only the outermost cathode current collector is the low meltability cathode current collector.
